(19) United States
(12) Patent Application Publication
(10) Pub. No.: US 2025/0093850 A1
(43) Pub. Date: Mar. 20, 2025

(54) DATA SYSTEM, DATA INTERFACE DEVICE, MANUFACTURING SYSTEM, AND METHOD FOR CONTROLLING MACHINE TOOL

(71) Applicant: DMG MORI Digital GmbH, Bielefeld (DE)

(72) Inventor: Juliane KARNATH, Steinhagen (DE)

(21) Appl. No.: 18/883,942

(22) Filed: Sep. 12, 2024

(30) Foreign Application Priority Data
Sep. 15, 2023 (DE) 102023125008.6

(51) Int. Cl. G05B 19/4155

(52) U.S. Cl. CPC G05B 19/4155; G05B 2219/32283

(57) ABSTRACT

A data system 100 for generating and transmitting job data to at least one numerically controlled machine tool 200a, 200b, comprising a data interface device 10, which in turn comprises an interface module 11 for data transmission and a data processing module 12 for data processing and data generation, a CAM system 20, which is configured for generating and providing NC programs for workpiece processing on a numerically controlled machine tool 200a, 200b and is coupled to the data interface device 10 by means of its interface module 11 for data transmission, and a production control system 30, which is configured for generating and providing manufacturing data for a product to be manufactured and/or for products to be manufactured and is coupled to the data interface device 10 by means of its interface module 11 for data transmission.

### CROSS REFERENCE TO RELATED APPLICATIONS

The present application claims priority to DE102023125008.6, filed Sep. 15, 2023, which is hereby incorporated herein by reference as if set forth in full.

### DESCRIPTION

### Technical Field

The present invention relates to a data system for generating and transmitting job data to a numerically controlled machine tool, a data interface device for use in a data system for generating and transmitting job data to a numerically controlled machine tool, a manufacturing system, and a method for controlling a numerically controlled machine tool.

### BACKGROUND OF THE INVENTION

In the field of the automated manufacturing of products, numerically controlled machine tools (NC or CNC machine tools) are usually used, which are arranged in a machine park in order to carry out the machining operations necessary for producing the products on the workpieces on which they are based.

The machine tools or their control device is supplied with data for a machining job to be carried out by the machine tool from different sources. In the course of this, the machine tool is generally provided with detailed information relating to a machining sequence, that is to say relating to the sequence of individual machining steps, and the NC programs required for these.

The information relating to the machining sequence is usually provided by a production control system (MES system for manufacturing execution system), whereas the NC programs are provided by a CAM system (computer-aided manufacturing system).

The provision of information or data necessary for carrying out a machining job is difficult, in particular when using a plurality of different machine tools (which is entirely the case in a machine park) and different CAM or production control systems, since these generally require in each case different transmission protocols for the data transmission or even different file and/or data formats of the data to be transmitted.

As a result, in particular the integration of new machine tools or alternative CAM and/or production control systems is made more difficult, since these require a prior manual adaptation to one another, which can be both time-intensive and cost-intensive and also adversely affects the flexibility of the manufacture in the machine park. This is made more difficult, in particular in the case of a heterogeneous machine park comprising old machines, foreign machines and new machines.

### SUMMARY

It is therefore an object of the present invention to provide a more efficient option for providing jobs to numerically controlled machine tools in a machine park.

To achieve this object, a data system according to claim 1, a data interface device according to claim 13, a manufacturing system according to claim 14, and a method for controlling a numerically controlled machine tool according to claim 15 are carried out.

The other dependent claims relate to preferred embodiments of the method or of the machine tool, which can each be carried out by themselves or in combination.

According to a first aspect of the invention, a data system for generating and transmitting job data to at least one numerically controlled machine tool is implemented, comprising a data interface device, which in turn comprises an interface module for data transmission and a data processing module for data processing and data generation, a CAM system, which is configured for generating and providing NC programs for workpiece processing on a numerically controlled machine tool and is coupled to the data interface device by means of its interface module for data transmission, and a production control system, which is configured for generating and providing manufacturing data for a product to be manufactured and/or for products to be manufactured and is coupled to the data interface device by means of its interface module for data transmission. The data interface device is configured, on the basis of an NC program dataset received from the CAM system and a manufacturing dataset received from the production control system, to generate a job dataset by means of the data processing module, which is readable by a numerically controlled machine tool, and to transmit said job dataset by means of the interface module to a numerically controlled machine tool coupled thereto, in particular to a control device of the machine tool.

The data system thus has, with the data interface device, a universal interface, which bundles the data to be previously transmitted to the machine tool largely manually (via USB stick etc.) and transmits said data to the machine tool collected as a job dataset.

In this way, workflows in the field of mass production are increasingly automated, which saves time and costs. Furthermore, errors or data losses in the data transmission to the machine tools can thus also be reduced.

As a further advantage, the flexibility in the machine park can also be increased as a result. Thus, for example, new machine tools can be integrated without a great deal of effort and can be supplied directly with data from the CAM and production control system via the data interface device.

A job dataset is a specific set of job data, a manufacturing dataset is a specific set of manufacturing data and an NC program dataset is a specific NC program or a collection of a plurality of specific NC subprograms.

NC programs are programs which can be carried out by a controller of a numerically controlled machine tool in order thus to control actuators of the machine tool in the manner specified in the NC program.

Depending on the machine tool, NC programs can differ in their data or file format and in their programming language.

Manufacturing data relate to the manufacturing sequence of the product to be manufactured and can contain a sequence of the machine tools to be run through, for example first machining on machine tool 1 and then additive machining on machine tool 2, etc. Likewise, the manufacturing data can also contain a chronological sequence of machining steps on an individual machine tool, for example first milling, then drilling, then grinding, etc.

In addition, the manufacturing data can also contain further data. The following may be mentioned without limitation: product name or title, customer information of the product recipient, priority level, technical drawings, load and obligation booklets, etc. All information contained in the manufacturing data can also be transmitted into the job data. It is preferably predetermined which parts of the manufacturing data are to be used for generating the job data.

Job data are to be understood as data usable by the receiving machine tool, which contains a combination of one or more NC programs or NC subprograms executable by the machine tool with data relating to the manufacturing sequence of the product to be manufactured.

Thus, the order dataset can contain information relating to a chronological sequence of machining steps, wherein an NC program usable by the machine tool or a plurality of NC subprograms which are carried out in accordance with the chronological sequence of the machining steps are stored in the order dataset for each machining step.

In particular, the NC (sub) programs stored in the job data are present in a file and data format readable or usable by the machine tool or in an executable programming language. The NC program stored in the job data can differ from the NC program provided by the CAM system.

The CAM system is to be understood here as an overview term for a pure CAM system, a CAM/CAD system or a pure CAD system (CAD: Computer-Aided-Design).

The data interface device is preferably configured to provide the order dataset to be transmitted in a file format suitable for the machine tool to be received or for the control device thereof and/or a suitable data format and/or the suitable programming language.

For this purpose, the data processing module can be configured to generate the job dataset proceeding from the manufacturing dataset and from the NC program dataset directly in the suitable file format and/or in the suitable data format and/or in the suitable programming language in such a way that the job dataset is readable by the machine tool or by the control device thereof.

Alternatively, the data system can comprise a translation module which is configured to translate a job dataset already generated by the data processing module into a job dataset readable for the machine tool to be received and to modify a file format of the generated job dataset into a suitable file format and/or a data format of the generated job dataset into a suitable data format and/or a programming language of the job dataset into a suitable programming language before the translated job dataset is transmitted via the interface module.

The data interface device is preferably not limited to a file format, data format or a programming language for the job dataset during the generation and/or translation, but can select the same in a suitable manner from a plurality of predefined file formats and/or a plurality of predefined data formats and/or a plurality of predefined programming languages.

Thus, the data interface device is preferably configured to communicate via the interface module with a plurality of machine tools, in particular with different machine tools, and to generate the job data corresponding to a file format, data format or usable programming language readable by the respective machine tool (or the control device thereof) and/or to adapt or to translate a file, data format or a programming language of a generated job dataset.

Preferably, the interface module is configured to select a suitable communication protocol from a plurality of communication protocols for the data transmission with a machine tool or with the control device thereof and/or with the CAM system and/or with the production control system. This enables the communication with a wide variety of different systems or control devices which use communication protocols deviating from the common standard, for example.

A communication protocol in the data transmission regulates the serialization of the data to be transmitted, which are thus transmitted in a sequential form from the transmitter to the receiver, wherein the receiver in question must of course be able to use the respective communication protocol. The data transmitted with the aid of the communication protocol are deserialized after receipt and are ultimately available for use by the receiver.

A Transmission Control Protocol (TCP), preferably with binary coding, or a Simple Object Access Protocol (SOAP) may be mentioned as non-limiting examples for the plurality of communication protocols.

In a preferred embodiment, the data interface device is implemented at least partially, in particular completely, as part of a first server structure, which is coupled to the CAM system and the production control system via Internet or an intranet connection for data transmission, in particular the data interface device is cloud-based.

Thus, the interface module can be provided locally, whereas the data processing module processing the data is provided on a server which is generally more powerful in terms of computing power. Alternatively, however, the interface module can also be provided on the server for the complete implementation.

This enables a central provision of the data interface device, so that it can be used across factory halls or even across locations.

In a preferred embodiment, the production control system is implemented at least partially as part of a second server structure, which is coupled to the data interface device via an Internet or an intranet connection for data transmission, in particular the production control system is cloud-based.

In a preferred embodiment, the CAM system is implemented at least partially as part of a third server structure, which is coupled to the data interface device via an Internet or an intranet connection for data transmission, in particular the CAM system is cloud-based.

As a result, the production control system and/or the CAM system can be provided at least partially on a centrally provided server, which can generally be implemented more powerful in terms of computing power. In addition, production control system and/or the CAM system can thus also be used across factory halls or even across locations.

Preferably, the CAM system and the production control system each have user interfaces, in particular local user interfaces, via which data can be input into the CAM or production control system on the server by an operator.

In a preferred embodiment, the interface module comprises a standardized API interface, in particular an open API interface, for data transmission with the CAM system and the production control system.

As a result, the CAM system and the production control system can be coupled to the data interface device in a particularly simple manner, so that in particular CAM systems and production control systems of different manufacturers can be coupled quickly.

In a preferred embodiment, the data interface device is configured to generate the job dataset on the basis of a plurality of production datasets received from the production control system.

As a result, for example, a prioritization of a plurality of processing orders can be performed. If, for example, production datasets with different prioritization are transmitted, a comparison of the priority level and a selection based thereon can be made by the data processing module as to which manufacturing dataset is first to be converted into a job dataset with the associated NC program dataset.

In a preferred embodiment, a manufacturing dataset generated by the production control system and receivable by the data interface device comprises one or more sub-datasets, each of which contains information relating to a manufacturing sequence for at least one product to be manufactured or relating to a machining sequence on a machine tool or relating to a priority level for at least one product to be manufactured.

In a preferred embodiment, the interface module of the data interface device is configured for data transmission with a plurality of production control systems, each of which is configured differently.

As a result, a plurality of production control systems can be used, for example from different locations or even different production control systems themselves.

In a preferred embodiment, the data processing module of the data interface device is configured to read out and process production datasets in at least two different data and/or file formats and/or programming languages.

In a preferred embodiment, the data system comprises N further production control systems, where N≥1, which are coupled to the data interface device by means of its interface module for data transmission.

In a preferred embodiment, the data system comprises M further CAM systems, where M≥1, which are coupled to the data interface device by means of its interface module for data transmission.

The functionalities of the data system can be extended by a plurality of production control systems and CAM systems. Thus, for example, in the case of a CAM system, non-existing functionalities can be retrofitted by incorporating another CAM system into the data system.

In a preferred embodiment, the interface module is configured for data transmission with a plurality of numerically controlled machine tools, each of which is configured differently and which differ from one another by differently configured control devices.

The data interface device is configured, as also already described above in a similar manner, to select a file format suitable for the receiving machine tool of the plurality of machine tools (or for the control device thereof) from a plurality of predefined file formats and/or a suitable data format from a plurality of predefined data formats and/or a suitable programming language from a plurality of predefined programming languages and to provide the job dataset to be transmitted to the relevant machine tool in the selected file format and/or in the selected data format and/or in the selected programming language.

For this purpose, the data processing module can be configured to generate the job dataset proceeding from the manufacturing dataset and from the NC program dataset directly in the selected file format and/or in the selected data format and/or in the selected programming language in such a way that the generated job dataset is readable by the machine tool or by the control device thereof.

Alternatively, the data system can also comprise for this purpose a translation module which is configured to translate a job dataset already generated by the data processing module into a job dataset readable for the machine tool to be received (or for the control device thereof) and to modify the data format of the generated job dataset into the selected data format and/or to modify the file format of the generated job dataset into the selected file format and/or to translate the programming language of the generated job dataset into the selected programming language before the translated job dataset is transmitted via the interface module.

In a preferred embodiment, the data interface device is configured to receive, by means of the interface module, a process dataset of workpiece processing generated by a numerically controlled machine tool and to forward this by means of the interface module to the CAM system and/or to the production control system.

In this way, the data interface device can be used at the same time as part of a process monitoring system in which, for example, process parameters are fed back to the production control system, so that a quality control can be performed there, for example.

In particular, the data interface device is preferably configured to translate, by means of a translation module, the process dataset received from the machine tool, before the forwarding, into a data format readable by the CAM system and/or by the production control system and/or a readable file format.

In a preferred embodiment, the process dataset generated by the numerically controlled machine tool contains recorded process parameters of the workpiece processing or information relating to error messages occurring during the workpiece processing or information relating to deviations from the order dataset, in particular relating to deviations from the NC program dataset predefined by the CAM system.

According to a second aspect of the invention, a data interface device for use in a data system for generating and transmitting job data to at least one numerically controlled machine tool is provided, in particular according to one of claims 1 to 12. The data interface device comprises an interface module for data transmission, and a data processing module for data processing and data generation, wherein the data interface device is configured, by means of the interface module, to receive from a CAM system NC programs for workpiece processing on a numerically controlled machine tool and manufacturing data for a product to be manufactured from a production control system, and is further configured, on the basis of an NC program dataset received from the CAM system and a manufacturing dataset received from the production control system, to generate a job dataset by means of the data processing module, which is readable by a numerically controlled machine tool, and to transmit said job dataset by means of the interface module to a numerically controlled machine tool coupled thereto, in particular to a control device of the machine tool.

In this way, an option is created for an existing system comprising CAM system and production control system to be able to be further developed comparatively quickly by the separately provided data interface device to form the data system according to the invention, with all the relevant advantages.

The features of the data interface device described above in the course of the data system also apply here with all the associated advantages, so that a further description thereof is dispensed with at this point.

According to a third aspect of the invention, a manufacturing system is provided which comprises a data system according to the first aspect or according to one of the preferred embodiments thereof and at least one numerically controlled machine tool. The at least one machine tool is coupled to the interface module of the data interface device of the data system for data transmission of job data and is at least configured to process a workpiece located in a working space of the at least one machine tool on the basis of a job dataset received from the data system.

In this way, an entire manufacturing system can be provided with the advantageous functionality of the data system according to the invention, which is distinguished by a higher degree of automation compared to known manufacturing systems.

According to a fourth aspect of the invention, a method for controlling a numerically controlled machine tool using a data system for generating and transmitting job data, in particular a data system according to the first aspect or according to one of the preferred embodiments thereof, is provided. The method comprises receiving a manufacturing dataset for a product to be manufactured by means of an interface module of a data interface device from a production control system, receiving an NC program dataset for workpiece processing on a numerically controlled machine tool by means of the interface module from a CAM system, generating a job dataset, which is readable by a numerically controlled machine tool, on the basis of the received NC program dataset and the received manufacturing dataset by means of a data processing module of the data interface device, transmitting the generated job dataset to the numerically controlled machine tool, in particular to the control device thereof, by means of the interface module, and controlling the numerically controlled machine tool as a function of the job dataset transmitted thereto.

The controlling of the machine tool is to be understood here as the controlling of one or more actuators of the machine tool in the course of the workpiece processing, for example, said actuators are linear, round, or pivot axes of a processing device or of a machine table, or drives for work spindles, or auxiliary systems (suction, coolant supply).

The method provided offers the option of operating a machine tool for the manufacture of a product in a largely fully automated manner, not only during the actual machining steps, but already for preparation in advance, which in turn saves time and costs.

Further aspects and the advantages thereof and also more specific exemplary embodiments of the abovementioned aspects and embodiments are described below with the aid of the drawings shown in the accompanying figures.

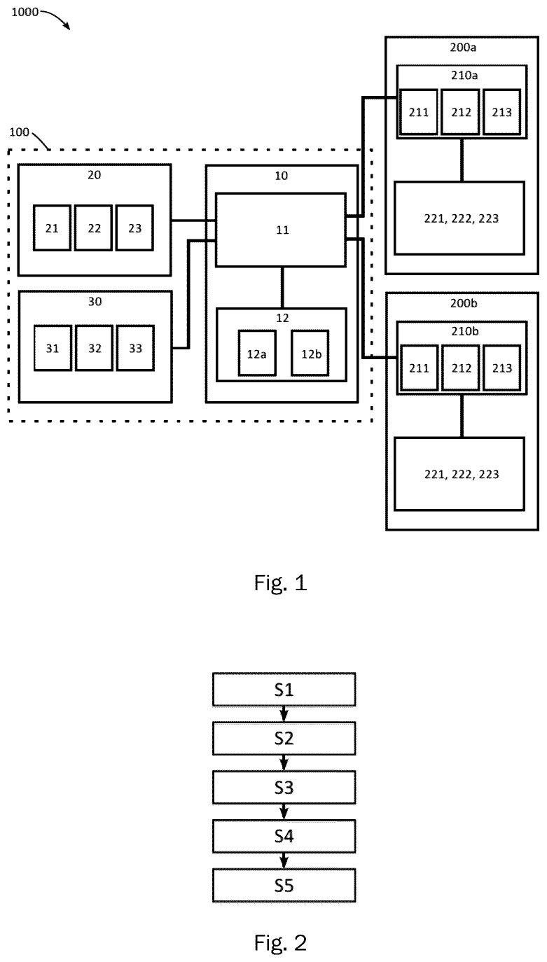

FIG. 1 shows a schematic view of an exemplary embodiment of the manufacturing system according to the invention, which comprises an exemplary embodiment of the data system according to the invention, which in turn comprises an exemplary embodiment of the data interface device according to the invention.

FIG. 2 shows a schematic flow diagram of an exemplary embodiment of the method according to the invention for controlling a numerically controlled machine tool.

It is emphasized that the present invention is in no way limited to the exemplary embodiments described below and the exemplary features thereof. The invention furthermore comprises modifications of the exemplary embodiments mentioned, in particular those which emerge from modifications and/or combinations of individual or a plurality of features of the exemplary embodiments described within the scope of protection of the independent claims.

### DETAILED DESCRIPTION OF THE FIGURES

FIG. 1 shows a schematic view of an exemplary embodiment of the manufacturing system 1000 according to the invention, which comprises an exemplary embodiment of the data system 100 according to the invention, which in turn comprises an exemplary embodiment of the data interface device 10 according to the invention.

The manufacturing system 1000 comprises the data system 100 and at least one numerically controlled machine tool 200a, in the present example additionally a further numerically controlled machine tool 200b.

The data system comprises a data interface device 10, a CAM system 20 and a production control system 30.

The data interface device 10 in turn comprises an interface module 11 for data transmission and a data processing module 12 for data processing and data generation, for which purpose it comprises by way of example a storage unit 12b and a CPU 12a.

The CAM system 20 is configured for generating and providing NC programs for workpiece processing on numerically controlled machine tools 200a, 200b and is coupled to the data interface device 10 by means of its interface module 11 for data transmission (represented by connecting line drawn in bold).

The production control system 30 is configured for generating and providing manufacturing data for a product to be manufactured and/or for products to be manufactured and is likewise coupled to the data interface device 10 by means of its interface module 11 for data transmission.

Both CAM system 20 and production control system 30 comprise by way of example as data processing systems in each case a CPU 21, 31 and a storage unit 22, 32. Furthermore, both systems 20, 30 have user interfaces 23, 33 via which user inputs can be detected and via which a user can input or modify an NC program dataset or a manufacturing dataset, for example.

The data interface device 10 is configured, on the basis of an NC program dataset received from the CAM system 20 and a manufacturing dataset received from the production control system 30, to generate a job dataset by means of the data processing module 12, which is readable by a numerically controlled machine tool 200a, 200b, and to transmit said job dataset by means of the interface module 11 to a numerically controlled machine tool 200a, 200b coupled thereto or to the respective control device 210a, 210b thereof.

The machine tools 200a, 200b or the control devices 210a, 210b thereof are coupled to the interface module 11 of the data interface device 10 of the data system 100 for data transmission of job data and are at least configured to process a workpiece located in a respective working space of the machine tool 200a, 200b on the basis of a job dataset received from the data system 100.

For this purpose, the machine tool 200a, 200b or the control devices 210a, 210b thereof are configured to control one or more actuators 221, 222, 223 of the machine tools 200a, 200b as a function of the received job dataset.

For data processing, the control devices 210a, 210b comprise by way of example in each case a CPU 211 and a storage unit 212, in which the received job dataset is preferably stored. In addition, the machine tool 200a, 200b can also be controlled via inputs at a respective user interface 213 of the control device 210a, 210b.

The two machine tools 200a, 200b can be configured differently, in particular the control devices 210a, 210b thereof, which originate from different manufacturers, for example.

The interface module 11 is configured for data transmission with the numerically controlled machine tools 200 configured differently or with the control devices 210 configured differently.

For this purpose, the data interface device 10 is configured in particular to select a file format suitable for the respective control device 210a, 210b of the machine tool 200a, 200b receiving the job dataset from a plurality of predefined file formats and/or a suitable data format from a plurality of predefined data formats and/or a suitable programming language from a plurality of predefined programming languages and to provide the job dataset to be transmitted to the relevant control device 210a, 210b in the selected file format and/or in the selected data format and/or in the selected programming language.

In this way, job datasets can be provided and transmitted via the data system 100 independently of an individual implementation of the control devices 210a, 210b.

The data system 100 provides an automated provision of job data to numerically controlled machine tools 200a, 200b via the data interface device 10 as a universal interface, which bundles the data to be previously transmitted to the machine tools 200a, 200b largely manually (via USB stick etc.) and transmits said data to the machine tools collected as a job dataset.

In this way, workflows in the field of mass production are increasingly automated, which saves time and costs and increases the flexibility in the machine park. Thus, for example, new machine tools can be integrated without a great deal of effort and can be supplied directly with data from the CAM system 20 and production control system 30 via the data interface device 10.

FIG. 2 shows a schematic flow diagram of an exemplary embodiment of the method according to the invention for controlling a numerically controlled machine tool using a data system for generating and transmitting job data.

In step S1, a manufacturing dataset for a product to be manufactured is received by means of an interface module of a data interface device from a production control system.

In step S2, an NC program dataset for workpiece processing on a numerically controlled machine tool is received by means of the interface module from a CAM system.

In step S3, a job dataset, which is readable by a numerically controlled machine tool, is generated on the basis of the NC program dataset received in step S2 and the manufacturing dataset received in step S1 by means of a data processing module of the data interface device.

In step S4, the job dataset generated in step S3 is transmitted to the numerically controlled machine tool, in particular to the control device thereof, by means of the interface module.

In step S5, the numerically controlled machine tool is controlled as a function of the job dataset transmitted thereto in step S4.

Exemplary embodiments of the present invention and the advantages thereof have been described in detail above with reference to the accompanying figures.

It is again emphasized that the present invention is in no way limited to the exemplary embodiments described above and the exemplary features thereof. The invention furthermore comprises modifications of the exemplary embodiments mentioned, in particular those which emerge from modifications and/or combinations of individual or a plurality of features of the exemplary embodiments described within the scope of protection of the independent claims.

### LIST OF REFERENCE SIGNS

10 Data interface device
11 Interface module
12 Data processing module
12a Storage unit
12b CPU
20 CAM system
21 CPU
22 Storage unit
23 User interface
30 Production control system
31 CPU
32 Storage unit
33 User interface
100 Data system
200a, 200b Machine tool
210a, 210b Control device of the Machine tool
211 CPU
212 Storage unit
213 User interface
221, 222, 223 actuators
1000 Manufacturing system

1. A data system for generating and transmitting job data to at least one numerically controlled machine tool, comprising:
a data interface device, which in turn comprises an interface module for data transmission and a data processing module for data processing and data generation,
a CAM system, which is configured for generating and providing NC programs for workpiece processing on a numerically controlled machine tool and is coupled to the data interface device by means of its interface module for data transmission, and
a production control system, which is configured for generating and providing manufacturing data for a product to be manufactured and/or for products to be manufactured and is coupled to the data interface device by means of its interface module for data transmission, wherein
the data interface device is configured, on the basis of an NC program dataset received from the CAM system and a manufacturing dataset received from the production control system, to generate a job dataset by means of the data processing module, which is readable by a numerically controlled machine tool, and to transmit said job dataset by means of the interface module to a numerically controlled machine tool coupled thereto, in particular to a control device of the machine tool.

2. The data system according to claim 1, wherein
the data interface device is implemented at least partially as part of a first server structure, which is coupled to the CAM system and the production control system via Internet or an intranet connection for data transmission, in particular the data interface device is cloud-based.

3. The data system according to claim 2, wherein
the production control system is implemented at least partially as part of a second server structure, which is coupled to the data interface device via an Internet or an intranet connection for data transmission, in particular the production control system is cloud-based, and/or
the CAM system is implemented at least partially as part of a third server structure, which is coupled to the data interface device via an Internet or an intranet connection for data transmission, in particular the CAM system is cloud-based.

4. The data system according to claim 1, wherein
the interface module comprises a standardized API interface, in particular an open API interface, for data transmission with the CAM system and the production control system.

5. The data system according to claim 1, wherein
the data interface device is set up to generate the order data record on the basis of a plurality of production data records received from the production control system.

6. The data system according to claim 1, wherein
a production data record generated by the production control system and receivable by the data interface device comprises one or more sub-data records, each of which contain information relating to a production sequence for at least one product to be manufactured or relating to a machining sequence on a machine tool or relating to a priority level for at least one product to be manufactured.

7. The data system according to claim 1, wherein
the interface module of the data interface device is configured for data transmission with a plurality of production control systems, each of which is configured differently.

8. The data system according to claim 7, wherein
the data processing module of the data interface device is configured to read out and process production data records in at least two different data and/or file formats.

9. The data system according to claim 1, wherein
the data system comprises N further production control systems, where N≥1, which are coupled to the data interface device by means of its interface module for data transmission, and/or
the data system comprises M further CAM systems, where M≥1, which are coupled to the data interface device by means of its interface module for data transmission.

10. The data system according to claim 1, wherein
the interface module is configured for data transmission with a plurality of numerically controlled machine tools, each of which is configured differently and which differ from one another by differently configured control devices, wherein
the data interface device is configured to select a file format suitable for the control device of the receiving machine tool of the plurality of machine tools from a plurality of predefined file formats and/or a suitable data format from a plurality of predefined data formats and/or a suitable programming language from a plurality of predefined programming languages and to provide the order data record to be transmitted to the relevant control device in the selected file format and/or in the selected data format and/or in the selected programming language.

11. The data system according to claim 1, wherein
the data interface device is configured to receive, by means of the interface module, a process data record of workpiece processing generated by a numerically controlled machine tool and to forward this by means of the interface module to the CAM system and/or to the production control system, wherein
the data processing module is preferably configured, by means of the data processing module, to translate the process dataset received from the machine tools, before the forwarding, into a data and/or file format readable by the CAM system and/or by the production control system.

12. The data system according to claim 11, wherein
the process dataset generated by the numerically controlled machine tool contains recorded process parameters of the workpiece processing or information relating to error messages occurring during the workpiece processing or information relating to deviations from the order dataset, in particular relating to deviations from the NC program predefined by the CAM system.

13. The data system according to claim 1, further comprising a data interface device for generating and transmitting job data to at least one numerically controlled machine tool, the data interface device comprising:
an interface module for data transmission, and
a data processing module for data processing and data generation, wherein
the data interface device is configured, by means of the interface module, to receive from a CAM system NC programs for workpiece processing on a numerically controlled machine tool and manufacturing data for a product to be manufactured from a production control system, and is further configured, on the basis of an NC program dataset received from the CAM system and a manufacturing dataset received from the production control system, to generate a job dataset by means of the data processing module, which is readable by a numerically controlled machine tool, and to transmit said job dataset by means of the interface module to a numerically controlled machine tool coupled thereto, in particular to a control device of the machine tool.

14. The data system of claim 1, wherein the data system is part of a manufacturing system, comprising:
at least one numerically controlled machine tool, wherein
the at least one machine tool is coupled to the interface module of the data interface device of the data system for data transmission of job data and is at least configured to process a workpiece located in a working space of the at least one machine tool on the basis of a job dataset received from the data system.

15. A method for controlling a numerically controlled machine tool using a data system for generating and transmitting job data, comprising:
receiving a manufacturing dataset for a product to be manufactured by means of an interface module of a data interface device from a production control system,
receiving an NC program dataset for workpiece processing on a numerically controlled machine tool by means of the interface module from a CAM system,
generating a job dataset, which is readable by a numerically controlled machine tool, on the basis of the received NC program dataset and the received manufacturing dataset by means of a data processing module of the data interface device,
transmitting the generated job dataset to the numerically controlled machine tool, in particular to the control device thereof, by means of the interface module, and
controlling the numerically controlled machine tool as a function of the job dataset transmitted thereto.
